(19) United States
(12) Patent Application Publication
(10) Pub. No.: US 2009/0126881 A1
(43) Pub. Date: May 21, 2009

(54) Valance apparatus

(76) Inventors: Gina Chi, Taichung (TW); Yi-Sheng Chuang, Taichung (TW); Tung-Jung Chen, Taichung (TW)

Correspondence Address: BUCHANAN INGERSOLL & ROONEY PC, P.O. BOX 1404, ALEXANDRIA, VA, 22313-1404, US

(21) Appl. No.: 12/228,382

(22) Filed: Aug. 12, 2008

(30) Foreign Application Priority Data
Nov. 16, 2007 (TW) 096219395

(51) Int. Cl. E06B 9/24; G06Q 10/00

(52) U.S. Cl. 160/368.1; 705/1

(57) ABSTRACT

A valance component that includes a first leg, a second leg, a rib extending between an intermediate portion of the first leg to an intermediate portion of the second leg and a member connected to the first and second legs is disclosed. The member has a first face that faces toward the first leg and a second face that faces toward the second leg. The member is sized and configured to be positioned between a valance side and a valance front member, which each have a groove sized to receive at least a portion of the first leg or the second leg. A kit is also disclosed that includes at least one of the valance components, two or more valance side members and at least one valance front member. The kit may include separately packaged components or components that are all retained within one package.

### CROSS REFERENCE TO RELATED APPLICATION

This application claims priority to Taiwanese Patent Application No. 096219395, filed Nov. 16, 2007.

### FIELD OF INVENTION

The present invention relates to valances for window coverings.

### BACKGROUND OF THE INVENTION

Homeowners often use valances to conceal the headrail of a blind, the roller tube of a roller shade or other fixtures that may be located above a window or window opening. Examples of various valances are disclosed in U.S. Pat. Nos. 6,629,481, 4,828,002, 4,662,421, 3,574,887, 2,526,806, 2,501,133 and D379,729.

Valances are typically mounted to a wall adjacent a window opening. Valances normally include a front member positioned in front of a headrail or other fixture and two side members that extend from the ends of the front member toward the wall surrounding the window opening such that the valance blocks the fixture from view. The valance side members are typically fastened to the ends of the valance front member by brackets, valance corners or other connectors.

Some valances include side members and a front member that each have a groove disposed in the rear side of each member. A bracket that has one end configured to fit within the groove of the front member and another end that is configured to fit within the groove of the side member can be used to connect each side member to the front member. Examples of various brackets that have been used to connect a valance front member to a valance side member are disclosed in U.S. Pat. No. 5,944,084. When brackets are used to connect a valance front member to a valance side member, a noticeable gap is often present between the two members. This gap typically detracts from the aesthetic effect the valance is intended to provide.

Other valances include valance corners that are positioned between the valance front member and each valance side member. Examples of some types of valance corners are disclosed in U.S. Pat. Nos. 5,636,674 and 4,921,031. Valance corners often have one or more projections that extend from two sides of the corner. The projections are typically configured to engage a portion of a valance front member or a portion of a valance side member to position the corner between the front and side members and connect the valance members together. Some valance corners are configured for attachment to a concealing strip that provides an aesthetic effect that is consistent with the aesthetic effect provided by the valance front member and valance side members.

Many valance corners, brackets or other connectors currently used to fasten a valance front member to a valance side member are sized and configured to be lightweight. However, we have recognized that the lightweight brackets, corners or other connectors are often unable to effectively connect relatively heavy valance side members to a relatively heavy valance front member. This is particularly true for valance corners or other connectors that include a body that is positioned between the valance front member and a valance side member. A lightweight valance component that can connect a valance front member to a valance side member is needed that is capable of connecting relatively heavy valance front members with relatively heavy valance side members. Preferably, the valance component is sized and configures so that an assembled valance appears to be a unitary structure.

The window covering industry has developed cut-down programs for venetian blinds, vertical blinds, pleated shades and cellular shades. Such programs provide a retailer with several standard size blinds and a machine which can be used to shorten the width of the blind to any desired width. The cutting machine typically includes a utility knife or other blade to shorten the length of the blind. Consequently, a home owner can take his or her window measurements to a retailer having a cut-down program, select among several styles of venetian blinds, vertical blinds, pleated shades and cellular shades, and have the selected blind cut to size while the customer waits. The cut-down process typically takes only a few minutes. So a buyer of venetian blinds, vertical blinds, pleated shades or cellular shades can take home a custom size blind the same day he or she selects the product. For this reason, cut-down programs have been very popular among buyers and sellers of window coverings.

Valances are typically sold as custom made products that must be prepared by a manufacturer after a retailer or customer delivers measurements and an order to the valance fabricator. U.S. Pat. No. 6,629,481, for instance, discloses a method employed to make custom made valances. To date, there have been no cut-down programs for valances. This is true even though valances have become more popular in recent years.

We have recognized that the popularity of cut-down programs for blinds, coupled with the increasing popularity of valances for window coverings, demonstrate a need for a valance or valance kit for assembling a valance that can be offered in a cut-down program and methods for making, selling and assembling such a valance. Preferably, the stock valances or valance kits are configured so that a window covering cutting machine used to cut down stock blinds is also able to cut down the stock valance or valance kit components.

### SUMMARY OF THE INVENTION

We provide a valance component that includes a first leg, a second leg, a rib and a member. The first leg has a first end, a second end and an intermediate portion between the first and second ends of the first leg. The second leg has a first end, a second end and an intermediate portion between the first and second ends of the second leg. The first end of the first leg is adjacent to the first end of the second leg such that the first leg is substantially perpendicular to the second leg. The rib extends from the intermediate portion of the first leg to the intermediate portion of the second leg. The member is connected to the first leg and the second leg adjacent the first end of the first leg and the first end of the second leg. The member has a first face that faces toward the first leg and a second face that faces toward the second leg. The member is sized and configured to be positioned between a valance side member and a valance front member. The valance side member and the valance front member each have a groove sized to receive a portion of at least one of the first leg or second leg.

The valance component may also include an adhesive on the first face or second face of the member. The adhesive can be covered by a removable covering. Preferably, the removable covering is configured for removal during the assembly of a valance.

The member can have a substantially triangular cross-section, a substantially rectangular cross-section or a substantially circular cross-section.

The member may also include an outer face that extends between the first face and the second face. The outer face preferably has a contoured surface and a wood-grain finish or a painted finish that matches or complements the finish and contoured surface of the valance front member or valance side members the valance component is configured to connect to.

A kit which includes two or more valance side members, one or more valance front members and one or more valance component connectors is also provided. Each valance side member and the valance front member have a channel. The one or more valance component connectors include a first leg, a second leg and a rib extending from an intermediate portion of the first leg to an intermediate portion of the second leg. A first end of the first leg is adjacent the first end of the second leg such that the first leg is at a position that is substantially perpendicular to the second leg. The rib, first leg and second leg form a unitary structure.

In some embodiments of the kit, the one or more valance component connectors will also include adhesive that is covered by a removable covering on at least one of the first face and second face of the member.

The one or more valance component connectors of the kit can also include a member connected to the first leg and the second leg adjacent the first end of the first leg and the first end of the second leg. The member has a first face that faces toward the first leg and a second face that faces toward the second leg. The member is sized and configured to be positioned between one of the valance side members and the valance front member.

The member of the one or more valance components can also include an outer face that extends between the first face and the second face. The outer face may have a contoured surface and may also have a wood-grain finish or a painted finish.

It should be understood that the components of the kit may be packaged and sold separately or packaged and sold together.

We also provide a method of selling valances. Our method includes offering at least two valance side members that have a channel, offering at least one valance front member that has a channel, and offering one or more valance component connectors that include a first leg, a second leg and a rib.

In some embodiments, the method may also include cutting at least one of the valance front members and the valance side members. The cutting may take place in a store or other location within a building that has a retail display offering valance side members, valance front members and valance component connectors.

Other embodiments of the method can further include assembling the one or more valance front members, valance side members and one or more valance component connectors. The assembling may occur in a store or in a building in which the assembled valance may be mounted.

Other objects and advantages of the present invention will become apparent from a description of certain present preferred embodiments thereof shown in the drawings.

### BRIEF DESCRIPTION OF THE DRAWINGS

Certain present preferred embodiments of the present invention are illustrated in the accompanying drawings:

FIG. 1 is a perspective view of a valance formed from a first present preferred embodiment of our valance kit that frames the headrail of a venetian blind.

FIG. 2 is an exploded front view of the first present preferred embodiment of our valance kit.

FIG. 3 is an exploded rear view of the first present preferred embodiment of our valance kit.

FIG. 4 is an enlarged top view of a present preferred embodiment of the first leg, second leg and rib portion of an embodiment of our valance component connector.

FIG. 5 is an exploded top view of a second present preferred embodiment of our valance kit.

FIG. 6 is a view similar to FIG. 5 of a third present preferred embodiment of our valance kit.

FIG. 7 is a view similar to FIGS. 5 and 6 of a fourth present preferred embodiment of our valance kit.

### DESCRIPTION OF THE PRESENT PREFERRED EMBODIMENTS

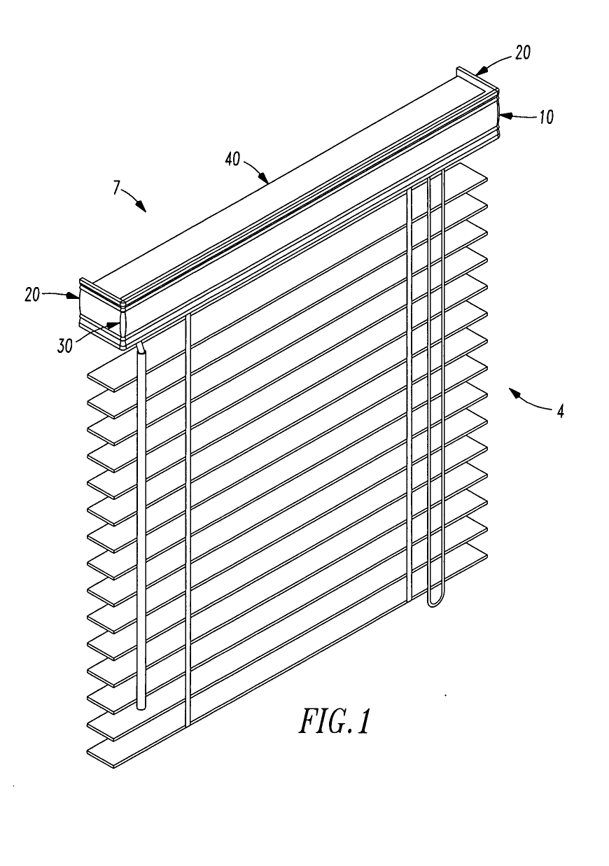

Referring to FIG. 1, a valance 7 formed from an embodiment of our valance kit frames the headrail 40 of a venetian blind 4. The valance 7 has a valance side member 20 connected to each end of a valance front member 10. A valance component connector 30 connects each side member 20 to the front member 10.

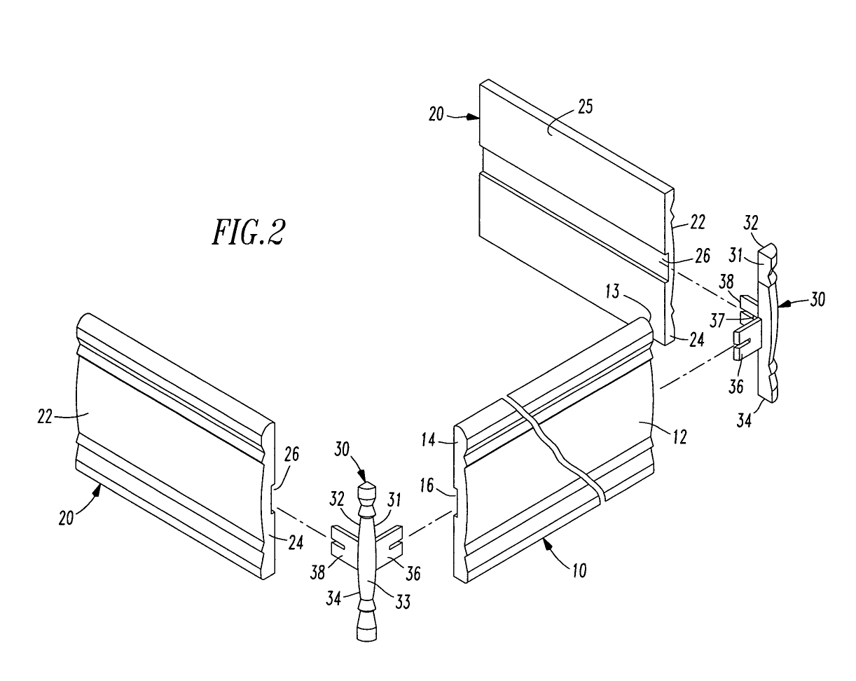

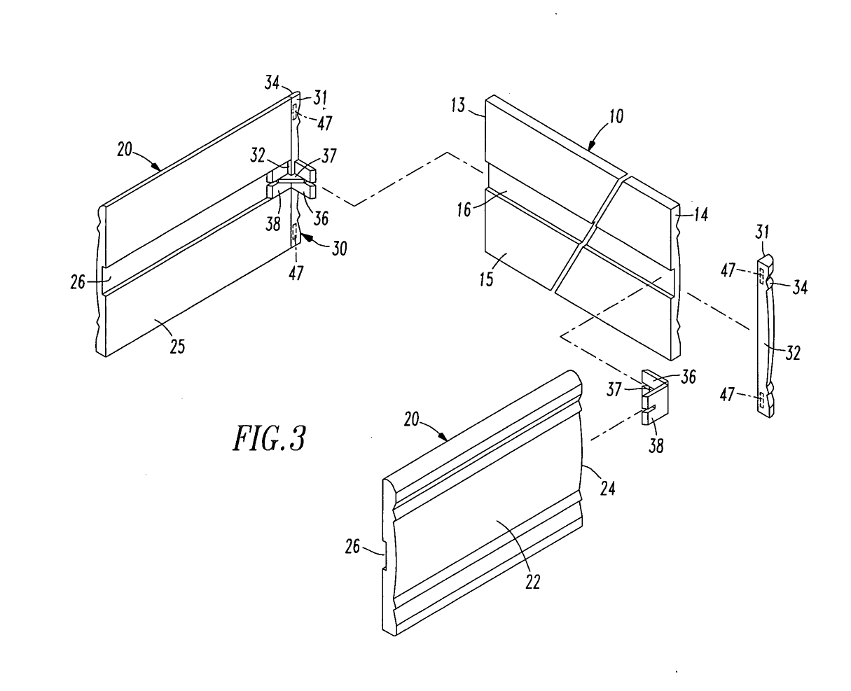

As best seen in FIGS. 2 and 3, a first present preferred embodiment of our valance kit includes a front valance member 10 that has a front surface 12, a first end 13, a second end 14 and a channel 16 formed within the back surface 15 of the valance front member 10. The channel 16 extends from the first end 13 to the second end 14. The front surface 12 may have a painted finish or a wood-grain finish. The front surface may also be contoured, as may best be appreciated from FIG. 2.

Two valance side members 20 are also provided. The valance side members 20 have a front surface 22 and at least one channel 26 formed in the back surface 25 of the valance side members 20. The channel 26 is formed such that a channel is adjacent at least one end 24 of the side member. The front surface 22 may have a painted finish or a wood-grain finish. Preferably, the finish of the front surface 22 compliments the finish of the front surface 12 of the valance front member 10. The valance side members 20 may also be contoured and preferably have a contour that compliments the contour of the valance front member 10.

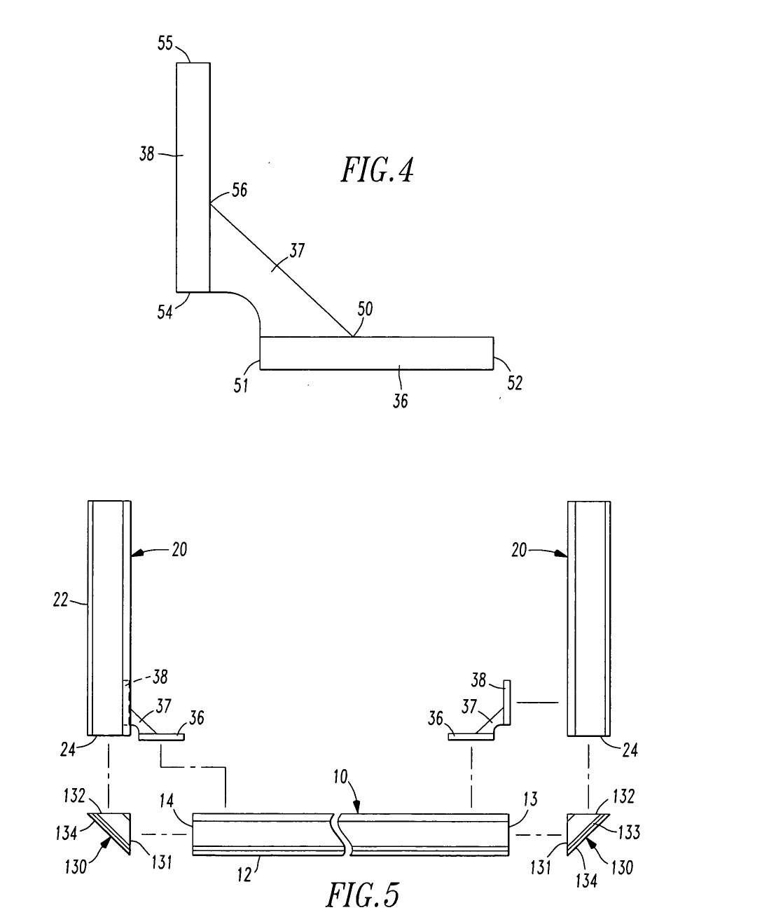

Each of the two valance component connectors 30 provided in the first present preferred embodiment of our valance kit is configured to connect a valance side member 20 to a valance front member 10. The valance component connector 30 has a first leg 36, a second leg 38, a rib 37 and a member 34. As may best be seen in FIG. 4, the first leg 36 has a first end 51, a second end 52 and an intermediate portion 50 between the first 51 and second 52 ends. The second leg 38 also has a first end 54, a second end 55 and an intermediate portion 56 between the first 54 and second 55 ends. It should be appreciated that the intermediate portion 50 may be any portion between end 51 and end 52. Similarly, intermediate portion 56 may be any portion of leg 38 between end 54 and end 55.

Rib 37 extends from the intermediate portion 50 of the first leg 36 to the intermediate portion 56 of the second leg 38. The first end 51 of the first leg 36 is positioned adjacent the first end 54 of the second leg 38 such that the first leg 36 is substantially perpendicular to the second leg 38.

The rib 37, first leg 36 and second leg 38 form a unitary structure. Preferably, the first leg 36, second leg 38, and rib 37 are formed of plastic. In other embodiments, it is contemplated that the first leg 36, second leg 38, and rib 37 may be formed from metal, wood or composites.

Leg 36 of each valance component connector is sized and configured to be received in channel 16 of the front valance member 10. In other embodiments, a discrete channel may be positioned adjacent each end 13 and 14 of the valance front member 10 to receive leg 36 from different valance component connectors.

Leg 38 of each valance component connector is sized and configured to be received in channel 26 of each valance side member 20. The channel 26 may be a channel that extends along the entire length of the valance side member or only extend from an end 24 of the side member 20 to an intermediate portion of the valance side member.

Preferably, legs 36 and 38 are similarly sized so that channels 16 and 26 may receive either legs 36 or 38. It is also contemplated that some embodiments of the valance component connector 30 may have different sized legs 36 and 38 and channel 26 of each side member 20 can have a different size or shape than the channel 16 of the valance front member 10. Such different sizing may be able to better insure a valance is properly assembled from various valance components by only permitting an assembler to connect the second leg 38 to the channel 26 of a side member 20 and only connect the first leg 36 to the channel 16 of the valance front member 10.

The rib 37 of the valance component connector 30 has been found to provide exceptional strength and toughness to the valance component connector. As a result, the legs 36 and 38 of the valance component connector are capable of holding relatively heavy valance front members and valance side members of an assembled valance that is mounted to frame a window covering or other fixture. Without the rib 37, legs 36 and 38 of the valance component connector can deform when received within and connected to relatively heavy valance members and, due to the deformation, are unable to sufficiently connect the relatively heavy valance front member to a relatively heavy valance side member once the assembled valance is mounted. Consequently rib 37 has been found to greatly increase the ability of embodiments of the valance component connector 30 to connect and support valance components assembled to form a valance as compared to various valance corners, valance brackets or other valance connectors.

The member 34 of the valance component connector 30 is connected to the first 36 and second 38 legs adjacent the first end 51 of the first leg 36 and the first end 54 of the second leg 38. The member 34 has a first face 31 that faces toward the first leg 36 and a second face 32 that faces toward the second leg 38. The member 34 is sized and configured to be positioned between a valance side member 20 and the valance front member 10. Preferably, the member 34 has a triangular cross-section, but may also have other cross-sections such as other polygonal cross-sections or a circular cross-section.

The member 34 also has an outer face 33 that extends from the first face 31 to the second face 32. The outer face 33 is configured to face toward the front of the valance front member or front of the valance side member when the valance component connector 30 is connected to those members to form a valance. Preferably, the outer face 33 has a contoured surface that compliments the front surface 12 of the valance front member 10 and the front surface 22 of the valance side members 20. The outer face 33 may also have a painted finish or wood-grain finish. The finish of the outer face 33 preferably complements the finish of the valance side members and valance front members so that an assembled and mounted valance appears to be a unitary structure.

It should be understood that the member 34 may be connected to the first leg 36, rib 37 or second leg 38. For example, the member 34 may be adhered to the first end 51 of the first leg 36 and the first end 54 of the second leg 38. The member 34 may also be molded with the first leg 36, second leg 38, and rib 37 such that the member 34, rib 37, first leg 36 and second leg 38 form a unitary structure.

The member of the valance component connector may have different shapes or forms to complement different end configurations of the valance side members 20 or valance front member 10. For example, if valance side members 20 and the valance front member 10 are configured to have straight ends 13, 14 and 24, as shown in FIG. 5, the member 134 may have a first face 131, second face 132 and outer face 133 that are arranged to have a right triangular cross section with the outer face 133 extending on an acute angle from the first face 131 to the second face 132.

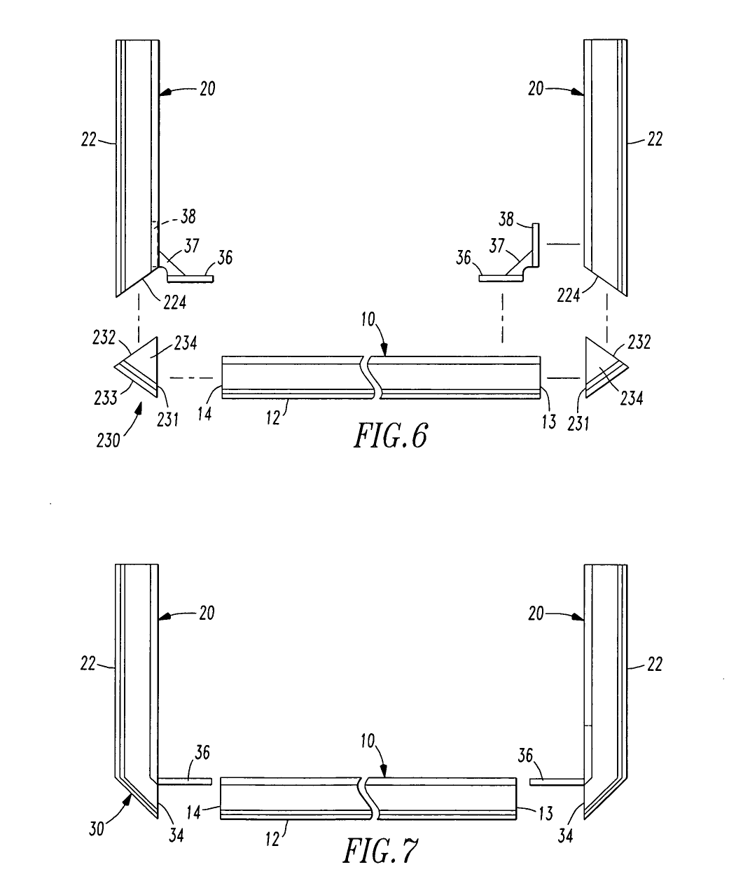

In the event that the valance side member have angled ends 224 and the valance front member has straight ends 13 and 14, the valance member 234 may have a front face 231, second face 232 and outer face 233 that are arranged to provide a non-right triangular cross-section, as shown in FIG. 6. It should be understood that the valance component connector 230 shown in FIG. 6 can be inserted between the angled end 224 of a valance side member 20 and the straight end 13 or 14 of the valance front member to form a valance that has a rectangular appearance.

Of course, for valances that are configured to form arc-like or circular shaped valances, the member of the valance component connector may be configured to provide a circular or arc-like outer face so the assembled valance may appear generally U-shaped or circular.

As may be appreciated from FIGS. 2, 3, 5, 6 and 7, a valance may be sold by selling a kit that includes at least one valance front member 10, two valance side members 20 and one or more valance component connectors 30. Preferably, there are at least two valance component connectors in the kit. The kit may also contain instructions that describe how a valance may be assembled with the components provided in the kit.

In some embodiments, the kit may be used to assemble a valance by inserting a first leg 36 of a valance component in the channel 16 adjacent each end 13 and 14 of the valance front member 10. The valance side members 20 may be connected to the valance front member 10 by inserting the second leg 38 of each valance component connector into a respective channel 26 of a valance side member 20. Legs 36 and 38 are sized and configured to frictionally engage the sidewalls of respective channels 16 and 26 to hold the valance side member 20 and valance front member 10 adjacent the member 34 of the valance component connector. Preferably, the member 34 has an outer face 33 that is configured to snugly fit between the front surface 12 of the valance front member 10 and the front surface 22 of a valance side member 20 so that the assembled valance appears to be a unitary structure.

As shown in dotted line in FIG. 3, the valance component connector 30 can include one or more adhesive strips 47 or other adhesives attached to the first face 31, second face 32 or both the first and second face of the member 34 to ensure the valance front member, valance side member 20 or both are snugly connected to the valance component connector 30. Preferably, the adhesive strips 47 include a removable cover so that the adhesive strip 47 can be attached to the first or second face of the member 34 prior to packaging the kit without inadvertently sticking to other valance components within a package or otherwise losing its adhesiveness. The removable cover may then be removed by an installer prior to or during the assembly of the valance.

It should be understood that embodiments of our kit may also include components that are partially assembled or preassembled. For instance, the embodiment of our kit shown in FIG. 7 includes valance side members 20 that are connected to the second leg of a respective valance component connector 30. The side members 20 and valance component connectors 30 are preassembled prior to packaging the kit components or offering the kit for sale. The valance assembled from such a kit may be quickly assembled by connecting the first leg 36 of each valance component connector to the channel 16 adjacent ends 13 and 14 of the valance front member 10.

Preferably, the channel 16 of the valance front member 10 extends from end 13 of the valance front member to end 14 of the valance front member. Such a full-length channel permits the valance front member to be cut down to frame various different sized headrail lengths by only being cut on one end of the valance front member.

Of course, the valance front member may also have discrete channels that extend a certain distance inward from each end 13, 14 of the valance front member 10. Such valance front members 10 may be cut down from one end or both ends, depending upon the length of each channel 16 and how much of the valance front member must be cut down to properly frame a particular headrail.

Embodiments of our kit permit valances to be sold with the option of cutting down the valance to properly frame a cut down stock blind. This permits retailers to sell embodiments of our kit with stock blinds. Consumers may then visit a retailer and purchase both a stock blind and stock valance without waiting for a custom made valance to be prepared for the consumer.

Further, if the consumer wishes to have a stock blind cut down to a particular size to fit his or her window opening, the stock valance may also be cut down to properly frame the cut down stock blind. The stock valance assembled from an embodiment of our kit may be cut down by cutting down the valance front member to adjust the length of the valance front member to properly frame the cut down stock blind. The valance side members may also be cut down to ensure the valance sufficiently projects from adjacent the window opening to properly frame the window covering. Of course, embodiments of our kit also permit stock valances to be sold and cut down separate from stock blinds.

It should be appreciated that use of the valance component connectors 30 to connect the valance front member 10 to the valance side members 20 provides a substantial aesthetic benefit to the cut down valance components. For example if the end of a valance component is not cut down cleanly, the member 34 of the valance component connector 30 effectively hides the rough cut of the end of the valance front member 10 or valance side member 20. Consequently, the need for a particularly clean cut is diminished, which can extend the useful life of a cutting blade on a cutting machine.

In addition to offering components of one or more embodiments of our valance kit and cutting down components of the kit to ensure a valance assembled from the kit will properly frame a window covering, a retailer may also offer to assemble the valance for a customer or install the assembled valance for a customer. Such assembly may be part of installation services or may be provided separately prior to the customer having the valance installed.

The valance assembled from an embodiment of our valance kit or sold in our method of selling valances may be cut down at the same time a window covering component is cut down or be cut down separately. Preferably, the valance front member or valance side members are configured so they may be cut down by the same cutting machine used to cut down window coverings offered by a retailer. Such valance components permit the valance front member or valance side members to be cut in a location that is in the same building that the retailer displays valance components, valances, stock blinds, embodiments of our valance kit or other window covering products.

Although we have described and illustrated certain present preferred embodiments of our valance component, kit for valances and methods of selling valances, the invention is not limited thereto and may be variously embodied within the scope of the following claims.

We claim:

1. A valance component comprising:
a first leg having a first end, a second end and an intermediate portion between the first and second ends of the first leg;
a second leg having a first end, a second end and an intermediate portion between the first and second ends of the second leg; the first end of the first leg being adjacent to the first end of the second leg such that the first leg is substantially perpendicular to the second leg;
a rib extending from the intermediate portion of the first leg to the intermediate portion of the second leg;
the first leg, the second leg, and the rib being a unitary structure; and
a member connected to the first leg and the second leg adjacent the first end of the first leg and the first end of the second leg, the member having a first face that faces toward the first leg and a second face that faces toward the second leg, the member being sized and configured to be positioned between a valance side member having a groove sized to receive at least a portion of one of the first leg and the second leg and a valance front member having a groove sized to receive at least a portion of one of the first leg and the second leg.

2. The valance component of claim 1 further comprising an adhesive on at least one of the first face and the second face, the adhesive covered by a removable covering.

3. The valance component of claim 1 wherein the member has a substantially triangular cross-section.

4. The valance component of claim 1 wherein the member has an outer face that extends between the first face and the second face, the outer face having one of wood-grain finish or a painted finish.

5. The valance component of claim 1 wherein the member has an outer face extended between the first face and second face the outer face having a contoured surface.

6. A kit comprising:
at least two valance side members, each side member having a channel;
at least one valance front member having a channel;
at least one valance component connector comprising a first leg having a first end, a second end and an intermediate portion between the first and second ends of the first leg, a second leg having a first end, a second end and an intermediate portion between the first and second ends of the second leg; the first end of the first leg being adjacent to the first end of the second leg such that the first leg is at a position that is substantially perpendicular to the second leg, the first leg and the second leg each sized and configured to be received within the channel of at least one of the valance front member and the valance side member, and a rib extending from the intermediate portion of the first leg to the intermediate portion of the second leg, the first leg, second leg and the rib being a unitary structure.

7. The kit of claim 6 wherein the at least one valance component connector is further comprised of a member connected to the first leg and the second leg adjacent the first end of the first leg and the first end of the second leg, the member having a first face that faces toward the first leg and a second face that faces toward the second leg, the member being sized and configured to be positioned between one of the valance side members and the valance front member.

8. The kit of claim 7 wherein the at least one valance component connector is further comprised of an adhesive on at least one of the first face and the second face, the adhesive covered by a removable covering.

9. The kit of claim 7 wherein the member of the at least one valance component has a substantially triangular cross-section.

10. The kit of claim 7 wherein the member of the at least one valance component has an outer face that extends between the first face and the second face, the outer face having one of a wood-grain finish or a painted finish.

11. The kit of claim 7 wherein the member of the at least one valance component has an outer face extended between the first face and second face, the outer face having a contoured surface.

12. The kit of claim 11 wherein at least one of the valance front member and the valance side members have a contoured face corresponding to the outer face of the member of the at least one valance component.

13. A method of selling valances comprising:
offering at least two valance side members, each valance side member having a channel;
offering at least one valance front member having a channel; and
offering at least one valance component connector comprising at least one valance component connector comprising a first leg having a first end, a second end and an intermediate portion between the first and second ends of the first leg, a second leg having a first end, a second end and an intermediate portion between the first and second ends of the second leg; the first end of the first leg being adjacent to the first end of the second leg such that the first leg is at a position that is substantially perpendicular to the second leg, the first leg and the second leg each sized and configured to be received within the channel of at least one of the valance front member and the valance side member, and a rib extending from the intermediate portion of the first leg to the intermediate portion of the second leg, the first leg, second leg and the rib being a unitary structure.

14. The method of claim 13 further comprising cutting at least one of the at least one valance front member and the at least two valance side members.

15. The method of claim 14 wherein the cutting takes place in a location that is located with a building having a retail display offering the at least two valance side members, the at least one valance front member and the at least one valance component connector.

16. The method of claim 13 further comprising providing instructions for assembling the at least one valance front member, at least two valance side members and at least one valance component connector.

17. The method of claim 13 wherein the at least one valance component connector is further comprised of a member connected to first leg and the second leg adjacent the first end of the first leg and the first end of the second leg, the member having a first face that faces toward the first leg and a second face that faces toward the second leg, the member being sized and configured to be positioned between one of the valance side members and one of the at least one valance front member.

18. The method of claim 17 wherein the at least one valance component connector is further comprised of an adhesive on at least one of the first face and the second face, the adhesive covered by a removable covering.

19. The method of claim 18 further comprising removing the removable covering.

20. The method of claim 17 further comprising assembling the at least one valance front member, the at least two valance side members and the at least one valance component connector such that at least a portion of the first face of the member engages the at least one front member and at least a portion of the second face of the member engages one of the at least two valance side members.
